(19) United States
(12) Patent Application Publication
(10) Pub. No.: US 2014/0218583 A1
(43) Pub. Date: Aug. 7, 2014

(54) Imaging Lens Having Five Lens Elements, and Electronic Apparatus Including the Same

(71) Applicant: Genius Electronic Optical Co., Ltd., Taichung City (TW)

(72) Inventors: Shih-Han Chen, Taichung City (TW); Chung-Chih Chang, Taichung City (TW); Cong-Hao Yang, Taichung City (TW); Chien-Jui Lin, Taichung City (TW)

(73) Assignee: GENIUS ELECTRONIC OPTICAL CO., LTD., Taichung City (TW)

(21) Appl. No.: 13/902,122

(22) Filed: May 24, 2013

(30) Foreign Application Priority Data
Feb. 6, 2013 (CN) 201310047565.0

(51) Int. Cl. G02B 13/00; H04N 5/225

(52) U.S. Cl. CPC G02B 13/0045; H04N 5/2254
USPC 348/335; 359/714

(57) ABSTRACT

An imaging lens includes first, second, third, fourth and fifth lens elements arranged from an object side to an image side in the given order. The first lens element has a positive refractive power. The second lens element has a negative refractive power, and has an object-side surface with a concave portion, and an image-side surface with a concave portion. The third lens element has an object-side surface with a concave portion. The fourth lens element has an image-side surface with a convex portion. The fifth lens element has an object-side surface with a concave portion.

### CROSS-REFERENCE TO RELATED APPLICATION

This application claims priority to Chinese Application No. 201310047565.0, filed on Feb. 6, 2013.

### BACKGROUND OF THE INVENTION

1. Field of the Invention

The present invention relates to an imaging lens having five lens elements, and an electric apparatus including the same.

2. Description of the Related Art

In recent years, as use of portable electronic devices (e.g., mobile phones and digital cameras) becomes ubiquitous, much effort has been put into reducing dimensions of portable electronic devices. Moreover, as dimensions of charged coupled device (CCD) and complementary metal-oxide semiconductor (CMOS) based optical sensors are reduced, dimensions of imaging lenses for use with the optical sensors must be correspondingly reduced without significantly compromising optical performance.

U.S. patent application publication nos. 20110176049, 20110316969, and U.S. Pat. No. 7,480,105 respectively disclose a conventional imaging lens with five lens elements, which include a first lens element with a negative refractive power.

U.S. patent application publication no. 20100254029, Japanese patent application publication no. 2008-281760, Taiwanese patent application publication no. 201227044, and Taiwanese patent nos. M369459 and 1268360 respectively disclose a conventional imaging lens with five lens elements, which include a thicker fifth lens element.

U.S. patent application publication nos. 20120069455, 20120087019, 20120087020, Japanese patent application publication nos. 2010-224521, 2010-152042, 2010-026434, and Taiwanese patent application publication nos. 201215942, 201213926, 201241499 respectively disclose a conventional imaging lens with five lens elements, whose sum of distances between each pair of adjacent lens elements thereof is too large.

In Japanese patent application publication no. 2008-281760, a system length of an imaging lens disclosed therein is over 16 mm, which disfavors thickness reduction of a portable electronic product, such as mobile phones and digital cameras.

### SUMMARY OF THE INVENTION

Therefore, an object of the present invention is to provide an imaging lens having a shorter overall length while maintaining good optical performance.

According to one aspect of the present invention, an imaging lens comprises first, second, third, fourth and fifth lens elements arranged from an object side to an image side in the given order. Each of the first, second, third, fourth and fifth lens elements has an object-side surface facing toward the object side and an image-side surface facing toward the image side.

The first lens element has a positive refractive power.

The second lens element has a negative refractive power, the object-side surface of the second lens element has a concave portion in a vicinity of an optical axis of the imaging lens, and the image-side surface of the second lens element has a concave portion in a vicinity of the optical axis.

The object-side surface of the third lens element has a concave portion in a vicinity of a periphery of the third lens element.

The image-side surface of the fourth lens element has a convex portion in a vicinity of the optical axis.

The object-side surface of the fifth lens element has a concave portion in a vicinity of the optical axis.

The imaging lens does not include any lens element with refractive power other than the first, second, third, fourth and fifth lens elements.

Another object of the present invention is to provide an electronic apparatus having an imaging lens with five lens elements.

According to another aspect of the present invention, an electronic apparatus includes a housing and an imaging module. The imaging module is disposed in the housing, and includes the imaging lens of the present invention, a barrel on which the imaging lens is disposed, a seat unit on which the barrel is disposed, and an image sensor disposed at the image side and operatively associated with the imaging lens for capturing images.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram to illustrate the structure of a lens element;

FIG. 2 is a schematic diagram that illustrates the first preferred embodiment of an imaging lens according to the present invention;

FIG. 3 shows values of some optical parameters corresponding to the imaging lens of the first preferred embodiment;

FIG. 4 shows values of some parameters of an optical relationship corresponding to the imaging lens of the first preferred embodiment;

FIGS. 5(a) to 5(d) show different optical characteristics of the imaging lens of the first preferred embodiment;

FIG. 6 is a schematic diagram that illustrates the second preferred embodiment of an imaging lens according to the present invention;

FIG. 7 shows values of some optical parameters corresponding to the imaging lens of the second preferred embodiment;

FIG. 8 shows values of some parameters of an optical relationship corresponding to the imaging lens of the second preferred embodiment;

FIGS. 9(a) to 9(d) show different optical characteristics of the imaging lens of the second preferred embodiment;

FIG. 10 is a schematic diagram that illustrates the third preferred embodiment of an imaging lens according to the present invention;

FIG. 11 shows values of some optical parameters corresponding to the imaging lens of the third preferred embodiment;

FIG. 12 shows values of some parameters of an optical relationship corresponding to the imaging lens of the third preferred embodiment;

FIGS. 13(a) to 13(d) show different optical characteristics of the imaging lens of the third preferred embodiment;

FIG. 14 is a schematic diagram that illustrates the fourth preferred embodiment of an imaging lens according to the present invention;

FIG. 15 shows values of some optical parameters corresponding to the imaging lens of the fourth preferred embodiment;

FIG. 16 shows values of some parameters of an optical relationship corresponding to the imaging lens of the fourth preferred embodiment;

FIGS. 17(a) to 17(d) show different optical characteristics of the imaging lens of the fourth preferred embodiment;

FIG. 18 is a schematic diagram that illustrates the fifth preferred embodiment of an imaging lens according to the present invention;

FIG. 19 shows values of some optical parameters corresponding to the imaging lens of the fifth preferred embodiment;

FIG. 20 shows values of some parameters of an optical relationship corresponding to the imaging lens of the fifth preferred embodiment;

FIGS. 21(a) to 21(d) show different optical characteristics of the imaging lens of the fifth preferred embodiment;

FIG. 22 is a schematic diagram that illustrates the sixth preferred embodiment of an imaging lens according to the present invention;

FIG. 23 shows values of some optical parameters corresponding to the imaging lens of the sixth preferred embodiment;

FIG. 24 shows values of some parameters of an optical relationship corresponding to the imaging lens of the sixth preferred embodiment;

FIGS. 25(a) to 25(d) show different optical characteristics of the imaging lens of the sixth preferred embodiment;

FIG. 26 is a schematic diagram that illustrates the seventh preferred embodiment of an imaging lens according to the present invention;

FIG. 27 shows values of some optical parameters corresponding to the imaging lens of the seventh preferred embodiment;

FIG. 28 shows values of some parameters of an optical relationship corresponding to the imaging lens of the seventh preferred embodiment;

FIGS. 29(a) to 29(d) show different optical characteristics of the imaging lens of the seventh preferred embodiment;

FIG. 30 is a table that lists values of parameters of other optical relationships corresponding to the imaging lenses of the first to seventh preferred embodiments;

FIG. 31 is a schematic partly sectional view to illustrate a first exemplary application of the imaging lens of the present invention; and

FIG. 32 is a schematic partly sectional view to illustrate a second exemplary application of the imaging lens of the present invention.

### DETAILED DESCRIPTION OF THE PREFERRED EMBODIMENTS

Before the present invention is described in greater detail, it should be noted that like elements are denoted by the same reference numerals throughout the disclosure.

In the following description, “a lens element has a positive (or negative) refractive power” means the lens element has a positive (or negative) refractive power in a vicinity of an optical axis thereof. “An object-side surface (or image-side surface) has a convex (or concave) portion at a certain area” means that, compared to a radially exterior area adjacent to said certain area, said certain area is more convex (or concave) in a direction parallel to the optical axis.

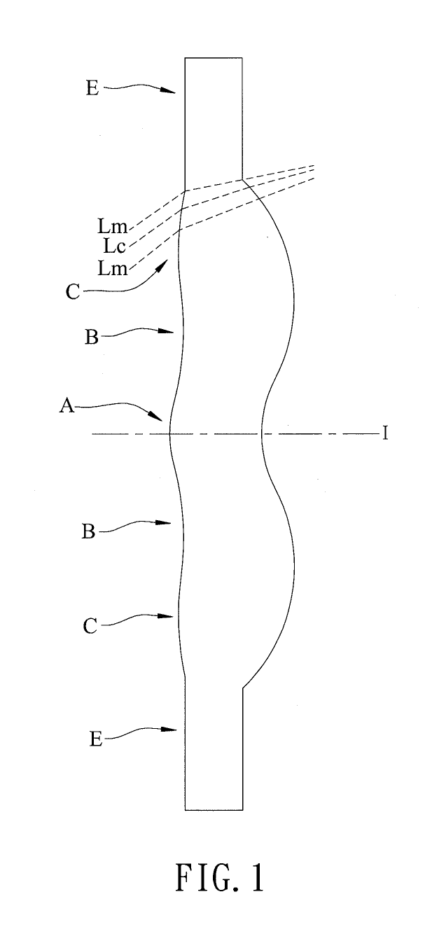

Referring to FIG. 1 as an example, the lens element is radially symmetrical to an optical axis (I) thereof. The object-side surface of the lens element has a convex portion at an area A, a concave portion at an area B, and a convex portion at an area C. This is because the area A is more convex in a direction parallel to the optical axis (I) in comparison with a radially exterior area thereof (i.e., area B), the area B is more concave in comparison with the area C, and the area C is more convex in comparison with an area E. “In a vicinity of a periphery” refers to an area around a periphery of a curved surface of the lens element for passage of imaging light only, which is the area C in FIG. 1. The imaging light includes a chief ray Lc and a marginal ray Lm. “In a vicinity of the optical axis” refers to an area around the optical axis of the curved surface for passage of the imaging light only, which is the area A in FIG. 1. In addition, the lens element further includes an extending portion E for installation into an optical imaging lens device. Ideally, the imaging light does not pass through the extending portion E. The structure and shape of the extending portion E are not limited herein. In the following embodiments, the extending portion E is not depicted in the drawings for the sake of clarity.

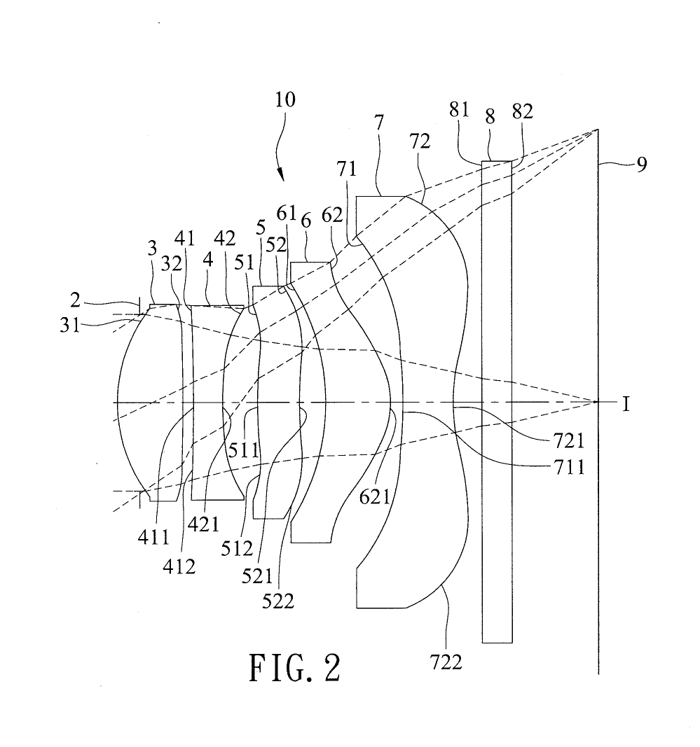

Referring to FIG. 2, the first preferred embodiment of an imaging lens 10 according to the present invention includes an aperture stop 2, first, second, third, fourth and fifth lens elements 3-7, and an optical filter 8 arranged in the given order along an optical axis (I) from an object side to an image side. The optical filter 8 is an infrared cut filter for selectively absorbing infrared light to thereby reduce imperfection of images formed at an image plane 9.

Each of the first, second, third, fourth and fifth lens elements 3-7 and the optical filter 8 has an object-side surface 31, 41, 51, 61, 71, 81 facing toward the object side, and an image-side surface 32, 42, 52, 62, 72, 82 facing toward the image side. Light entering the imaging lens 10 travels through the aperture stop 2, the object-side and image-side surfaces 31, 32 of the first lens element 3, the object-side and image-side surfaces 41, 42 of the second lens element 4, the object-side and image-side surfaces 51, 52 of the third lens element 5, the object-side and image-side surfaces 61, 62 of the fourth lens element 6, the object-side and image-side surfaces 71, 72 of the fifth lens element 7, and the object-side and image-side surfaces 81, 82 of the optical filter 8, in the given order, to form an image on the image plane 9. Each of the object-side surfaces 31, 41, 51, 61′, 71 and the image-side surfaces 32, 42, 52, 62, 72 is aspherical and has a center point coinciding with the optical axis (I).

The lens elements 3-7 are made of plastic material in this embodiment, and at least one of them may be made of other materials in other embodiments.

In the first preferred embodiment, which is depicted in FIG. 2, the first lens element 3 has a positive refractive power. The object-side surface 31 of the first lens element 3 is a convex surface, and the image-side surface 32 of the first lens element 3 is a convex surface.

The second lens element 4 has a negative refractive power. The object-side surface 41 of the second lens element 4 is a concave surface that has a concave portion 411 in a vicinity of the optical axis (I) and a concave portion 412 in a vicinity of a periphery of the second lens element 4. The image-side surface 42 of the second lens element 4 is a concave surface that has a concave portion 421 in a vicinity of the optical axis (I).

The third lens element 5 has a positive refractive power. The object-side surface 51 of the third lens element 5 has a convex portion 511 in a vicinity of the optical axis (I) and a concave portion 512 in a vicinity of a periphery of the third lens element 5. The image-side surface 52 of the third lens element 5 has a concave portion 521 in a vicinity of the optical axis (I) and a convex portion 522 in a vicinity of the periphery of the third lens element 5.

The fourth lens element 6 has a positive refractive power. The object-side surface 61 of the fourth lens element 6 is a concave surface. The image-side surface 62 of the fourth lens element 6 is a convex surface that has a convex portion 621 in a vicinity of the optical axis (I).

The fifth lens element 7 has a negative refractive power. The object-side surface 71 of the fifth lens element 7 is a concave surface that has a concave portion 711 in a vicinity of the optical axis (I). The image-side surface 72 of the fifth lens element 7 has a concave portion 721 in a vicinity of the optical axis (I) and a convex portion 722 in a vicinity of the periphery of the fifth lens element 7.

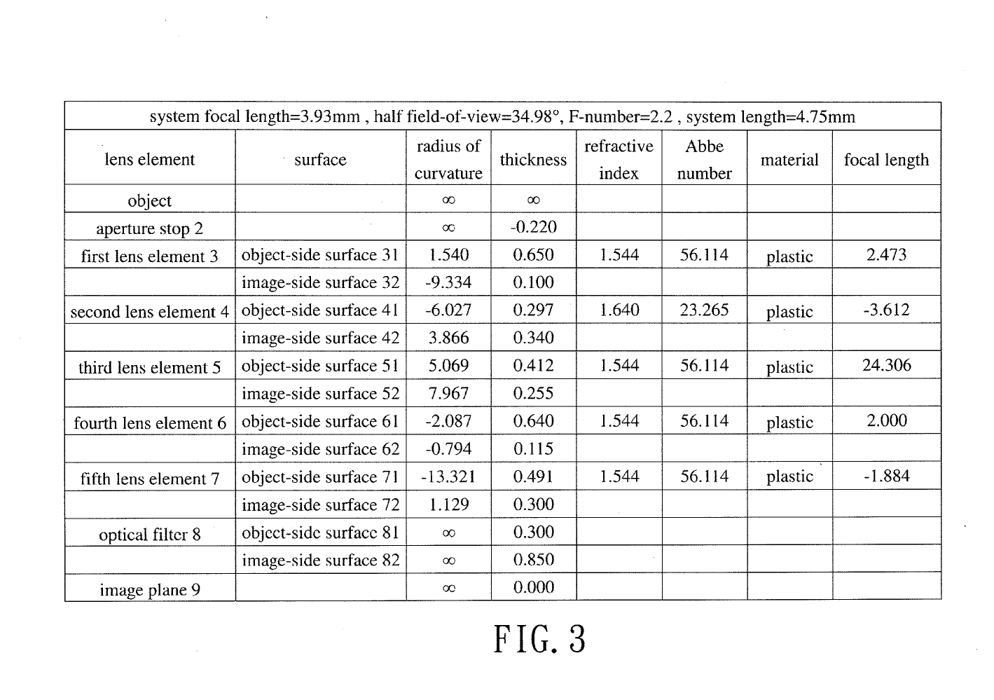

Shown in FIG. 3 is a table that lists values of some optical parameters corresponding to the surfaces 31-71, 32-72 of the first preferred embodiment. The imaging lens 10 has an overall system effective focal length (EFL) of 3.93 mm, a half field-of-view (HFOV) of 34.98°, an F-number of 2.2, and a system length of 4.75 mm. The system length refers to a distance between the object-side surface 31 of the first lens element 3 and the image plane 9.

In this embodiment, each of the object-side surfaces 31-71 and the image-side surfaces 32-72 is aspherical, and satisfies the optical relationship of

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i} \qquad ( 1 )$$

where:

R represents a radius of curvature of the aspherical surface;

Z represents a depth of an aspherical surface, which is defined as a perpendicular distance between an arbitrary point on the aspherical surface that is spaced apart. from the optical axis (I) by a distance Y, and a tangent plane at a vertex of the aspherical surface at the optical axis (I);

Y represents a perpendicular distance between the arbitrary point on the aspherical surface and the optical axis (I);

K represents a conic constant; and

a₂ᵢ represents a 2i^{th} aspherical coefficient.

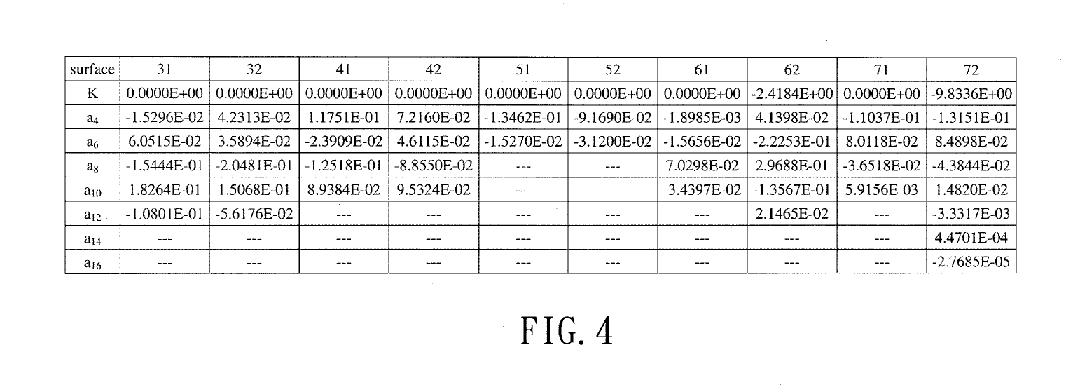

Shown in FIG. 4 is a table that lists values of some optical parameters of the aforementioned optical relationship (1) corresponding to the first preferred embodiment.

Relationships among some of the aforementioned optical parameters corresponding to the first preferred embodiment are as follows:

CT4/AC34=2.51

CT2/AC23=0.87

CT4/AAG=0.79

CT4/CT2=2.15

CT4/CT3=1.55

AC23/AAG=0.42

where:

CT2 represents a distance between the object-side surface 41 and the image-side surface 42 of the second lens element 4 at the optical axis (I);

CT3 represents a distance between the object-side surface 51 and the image-side surface 52 of the third lens element 5 at the optical axis (I);

CT4 represents a distance between the object-side surface 61 and the image-side surface 62 of the fourth lens element 6 at the optical axis (I);

AAG represents a sum of a distance between the image-side surface 32 of the first lens element 3 and the object-side surface 41 of the second lens element 4 at the optical axis (I), a distance between the image-side surface 42 of the second lens element 4 and the object-side surface 51 of the third lens element at the optical axis (I), a distance between the image-side surface 52 of the third lens element 5 and the object-side surface 61 of the fourth lens element 6 at the optical axis (I), and a distance between the image-side surface 62 of the fourth lens element 6 and the object-side surface 71 of the fifth lens element 7 at the optical axis (I);

AC23 represents the distance between the image-side surface 42 of the second lens element 4 and the object-side surface 51 of the third lens element 5 at the optical axis (I); and

AC34 represents the distance between the image-side surface 52 of the third lens element 5 and the object-side surface 61 of the fourth lens element 6 at the optical axis (I).

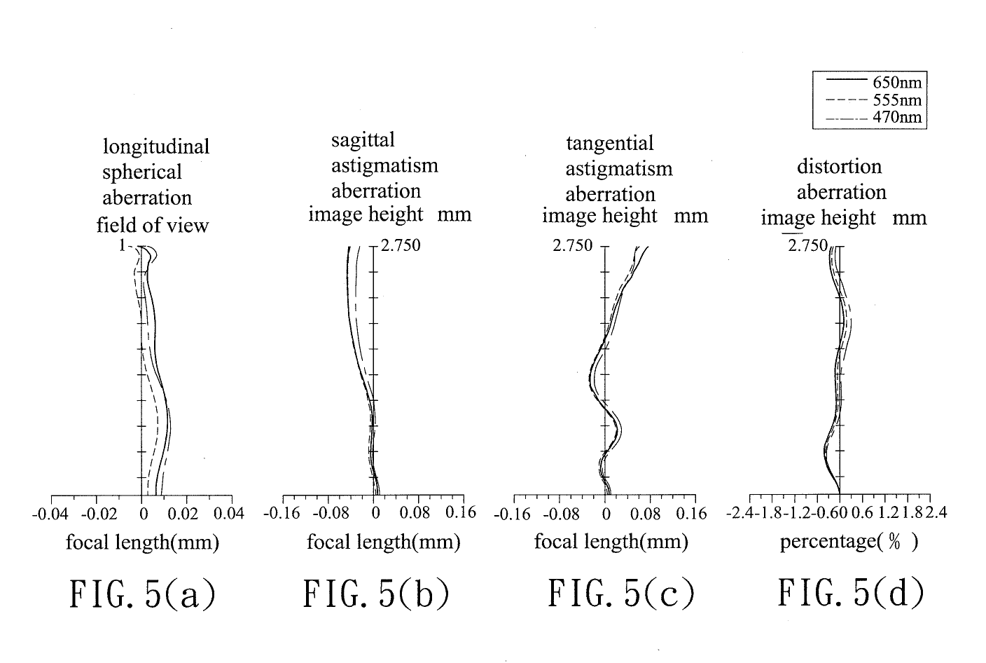

FIGS. 5(a) to 5(d) show simulation results corresponding to longitudinal spherical aberration, sagittal astigmatism aberration, tangential astigmatism aberration, and distortion aberration of the first preferred embodiment, respectively. In each of the simulation results, curves corresponding respectively to wavelengths of 470 nm, 555 nm, and 650 nm are shown.

It can be understood from FIG. 5(a) that, since each of the curves corresponding to longitudinal spherical aberration has a focal length at each field of view (indicated by the vertical axis) that falls within the range of ±0.015 mm, the first preferred embodiment is able to achieve a relatively low spherical aberration at each of the wavelengths. Furthermore, since a deviation in focal length among the curves at each field of view does not exceed the range of ±0.01 mm, the first preferred embodiment has a relatively low chromatic aberration.

It can be understood from FIGS. 5 (b) and 5 (c) that, since each of the curves falls within the range of ±0.08 mm of focal length, the first preferred embodiment has a relatively low optical aberration.

Moreover, as shown in FIG. 5(d), since each of the curves corresponding to distortion aberration falls within the range of ±0.6%, the first preferred embodiment is able to meet requirements in imaging quality of most optical systems.

In view of the above, even with the system length reduced down to 4.75 mm, the imaging lens 10 of the first preferred embodiment is still able to achieve a relatively good optical performance.

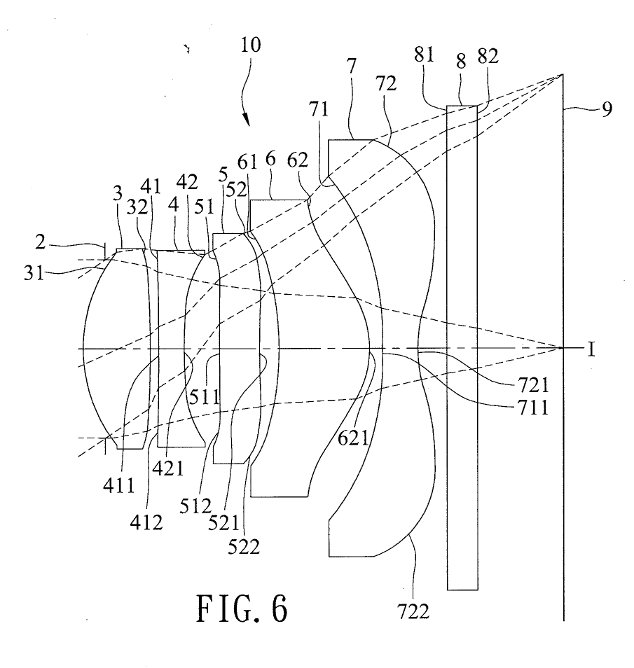

FIG. 6 illustrates the second preferred embodiment of an imaging lens 10 according to the present invention, which has a configuration similar to that of the first preferred embodiment.

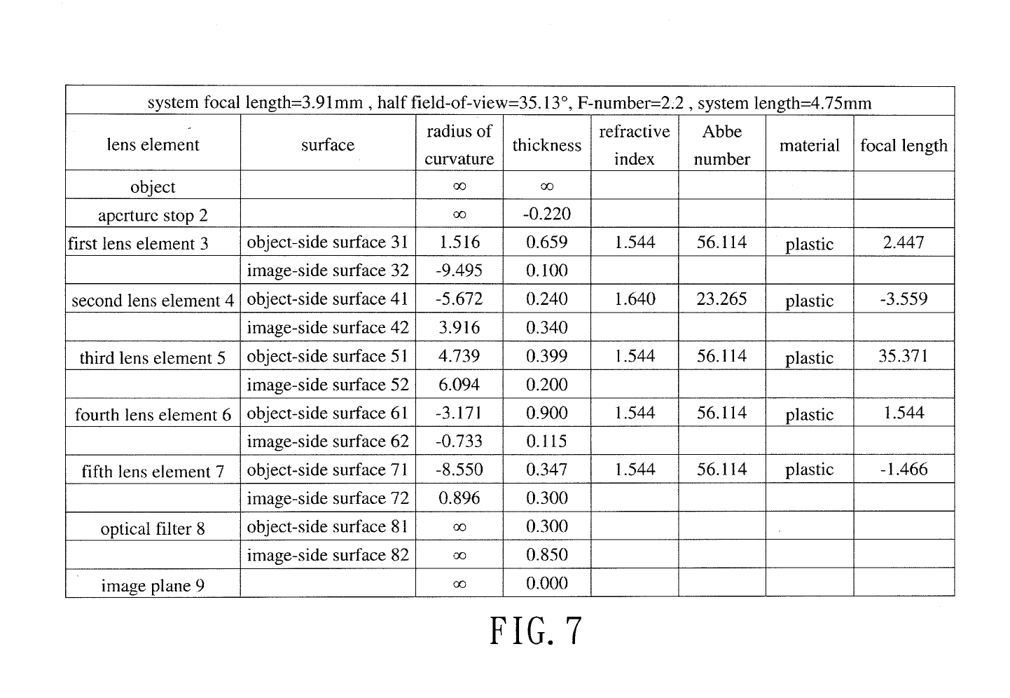

Shown in FIG. 7 is a table that lists values of some optical parameters corresponding to the surfaces 31-71, 32-72 of the second preferred embodiment. The imaging lens 10 has an overall system focal length of 3.91 mm, an HFOV of 35.13°, an F-number of 2.2, and a system length of 4.75 mm.

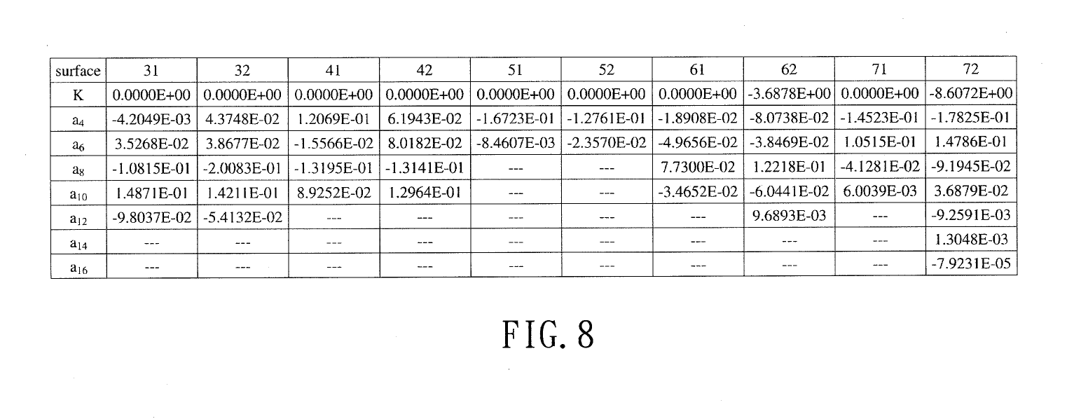

Shown in FIG. 8 is a table that lists values of some optical parameters of the aforementioned optical relationship (1) corresponding to the second preferred embodiment.

Relationships among some of the aforementioned optical parameters corresponding to the second preferred embodiment are as follows:

CT4/AC34=4.50

CT2/AC23=0.71

C4/AAG=1.19

CT4/CT2=3.75

CT4/CT3=2.26

AC23/AAG=0.45

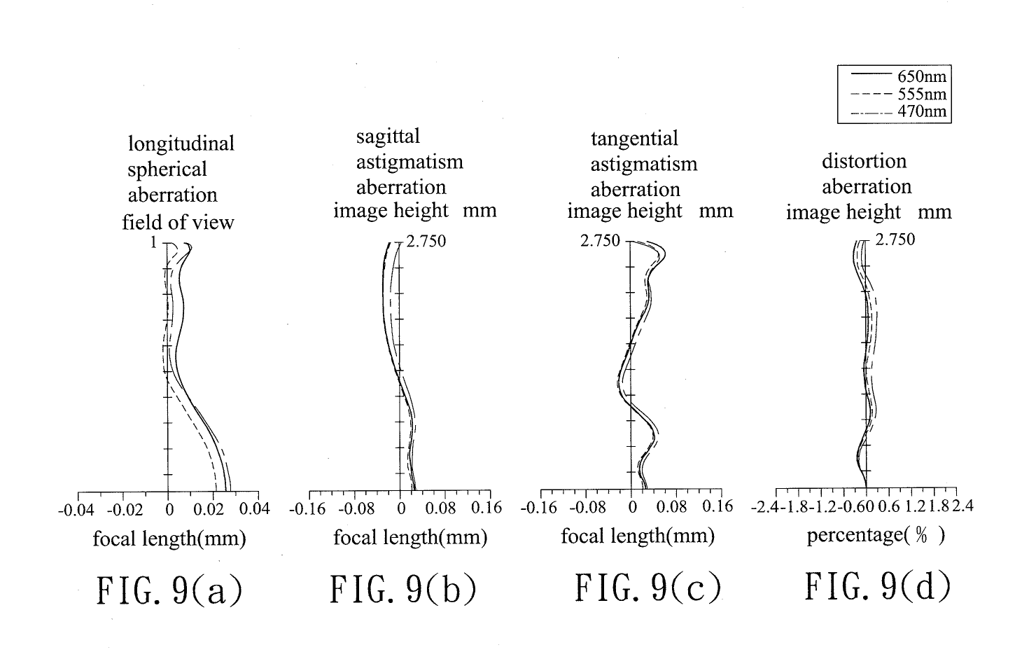

FIGS. 9(a) to 9(d) show simulation results corresponding to longitudinal spherical aberration, sagittal astigmatism aberration, tangential astigmatism aberration, and distortion aberration of the second preferred embodiment, respectively. It can be understood from FIGS. 9(a), 9(b), 9(c) and 9(d) that the second preferred embodiment is able to achieve a relatively good optical performance even with the system length reduced down to 4.75 m.

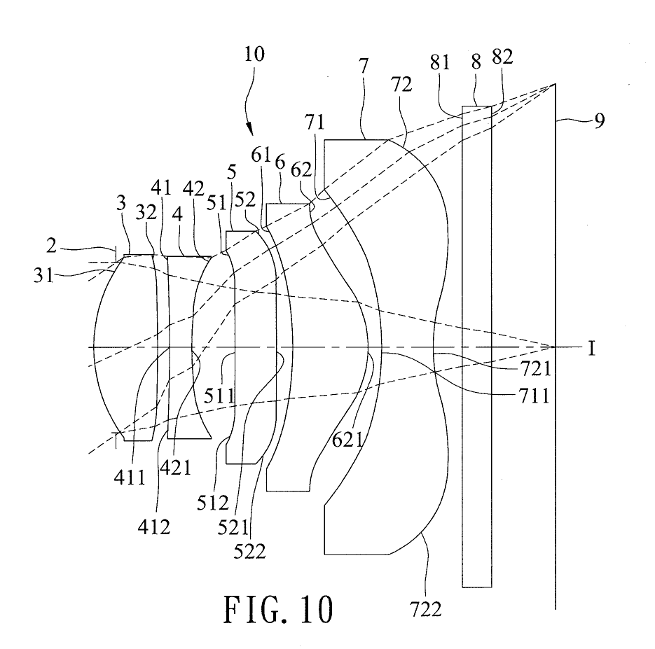

FIG. 10 illustrates the third preferred embodiment of an imaging lens 10 according to the present invention, which has a configuration similar to that of the first preferred embodiment.

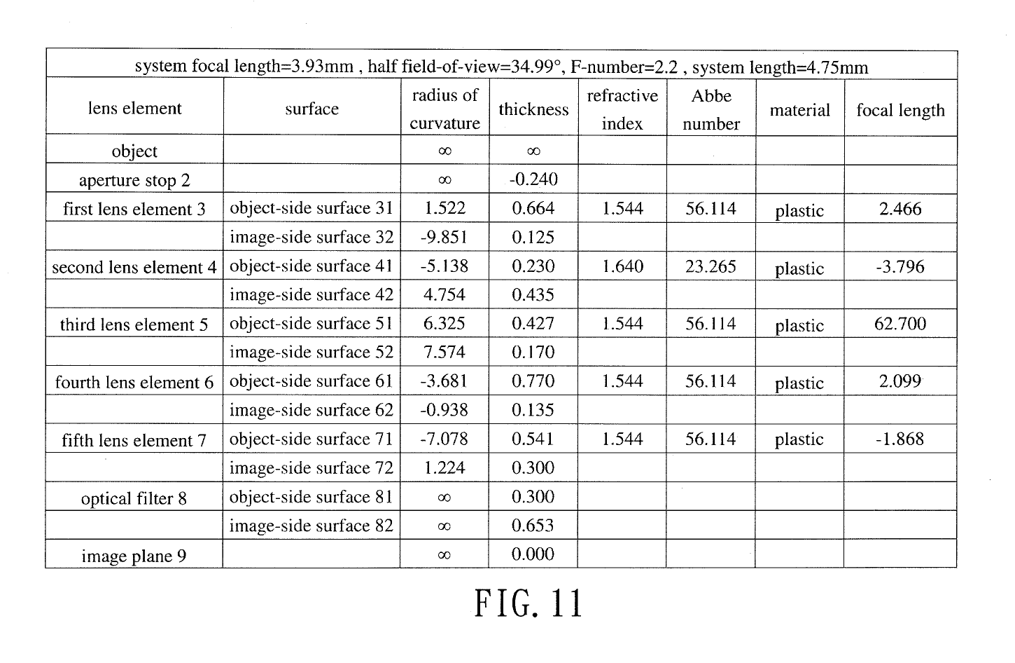

Shown in FIG. 11 is a table that lists values of some optical parameters corresponding to the surfaces 31-71, 32-72 of the third preferred embodiment. The imaging lens 10 has an overall system focal length of 3.93 mm, an HFOV of 34.99°, an F-number of 2.2, and a system length of 4.75 mm.

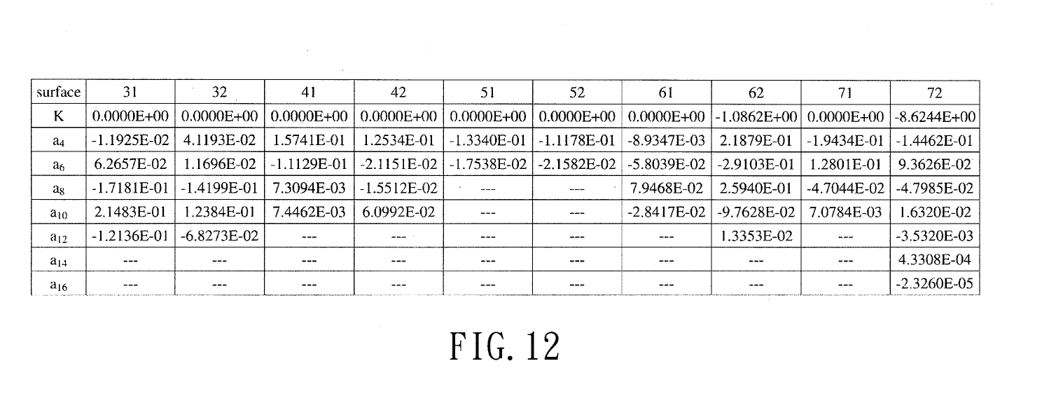

Shown in FIG. 12 is a table that lists values of some optical parameters of the aforementioned optical relationship (1) corresponding to the third preferred embodiment.

Relationships among some of the aforementioned optical parameters corresponding to the third preferred embodiment are as follows:

CT4/AC34=4.53

CT2/AC23=0.53

CT4/AAG=0.89

CT4/CT2=3.35

CT4/CT3=1.80

AC23/AAG=0.50

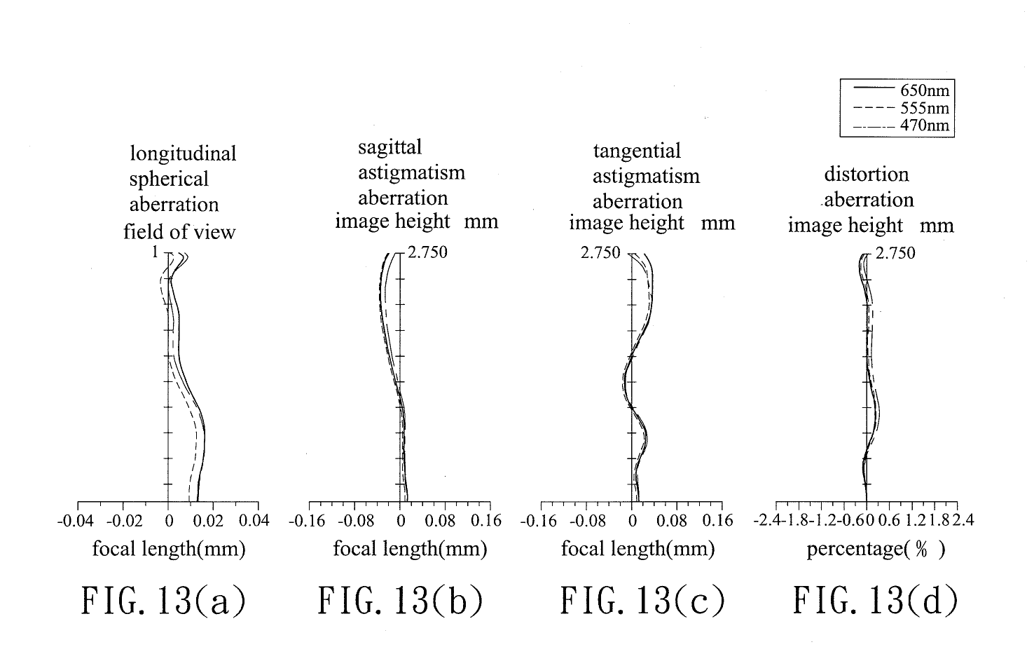

FIGS. 13(a) to 13(d) show simulation results corresponding to longitudinal spherical aberration, sagittal astigmatism aberration, tangential astigmatism aberration, and distortion aberration of the third preferred embodiment, respectively. It can be understood from FIGS. 13(a), 13(b), 13 (c) and 13(d) that the third preferred embodiment is likewise able to achieve a relatively good optical performance even with the system length reduced down to 4.75 mm.

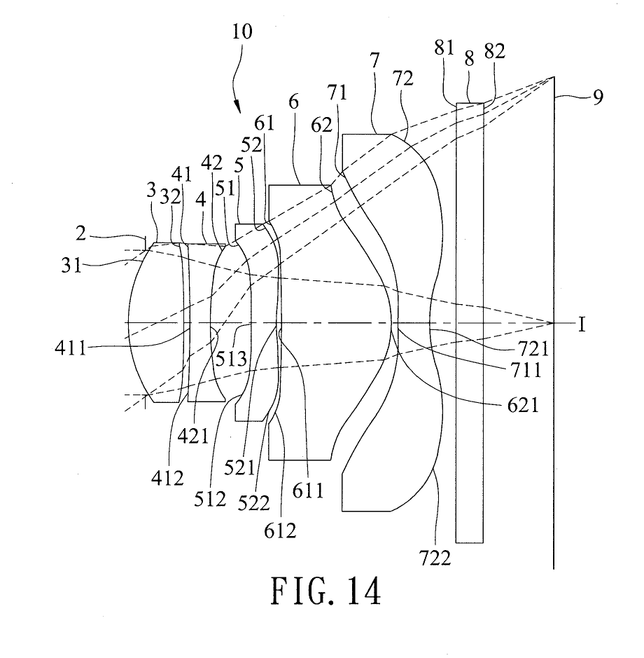

Referring to FIG. 14, the differences between the first and fourth preferred embodiments reside in that:

The third lens element 5 has a negative refractive power. The object-side surface 51 of the third lens element 4 is a concave surface that has a concave portion 513 in a vicinity of the optical axis (I). The object-side surface 61 of the fourth lens element 6 has a convex portion 611 in a vicinity of the optical axis (I) and a concave portion 612 in a vicinity of the periphery of the fourth lens element 6.

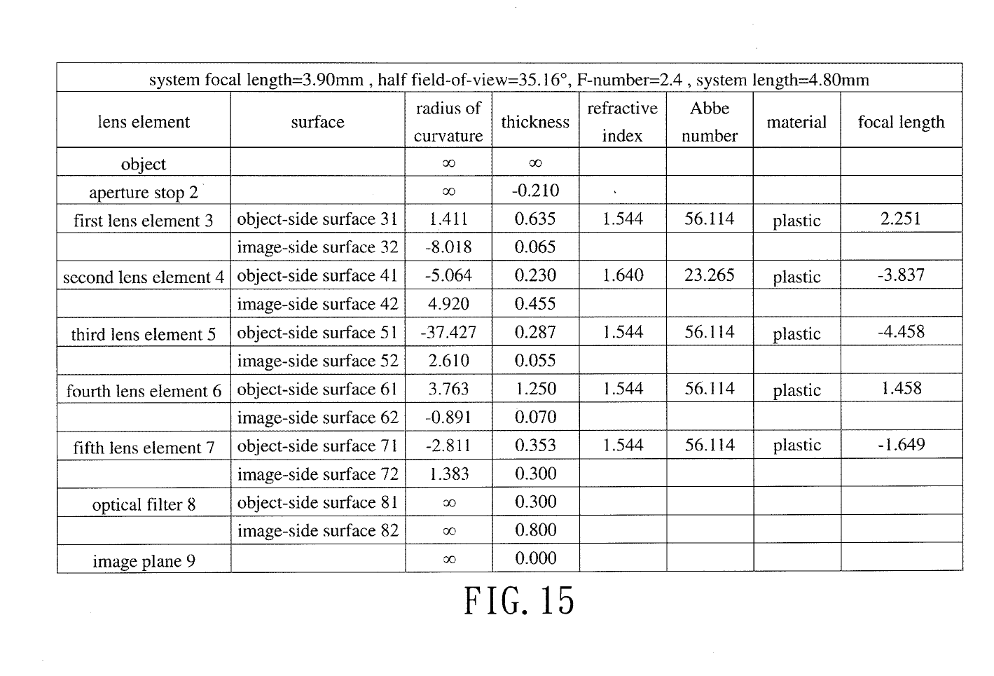

Shown in FIG. 15 is a table that lists values of some optical parameters corresponding to the surfaces 31-71, 32-72 of the fourth preferred embodiment. The imaging lens 10 has an overall system focal length of 3.90 mm, an HFOV of 35.16°, an F-number of 2.4, and a system length of 4.80 mm.

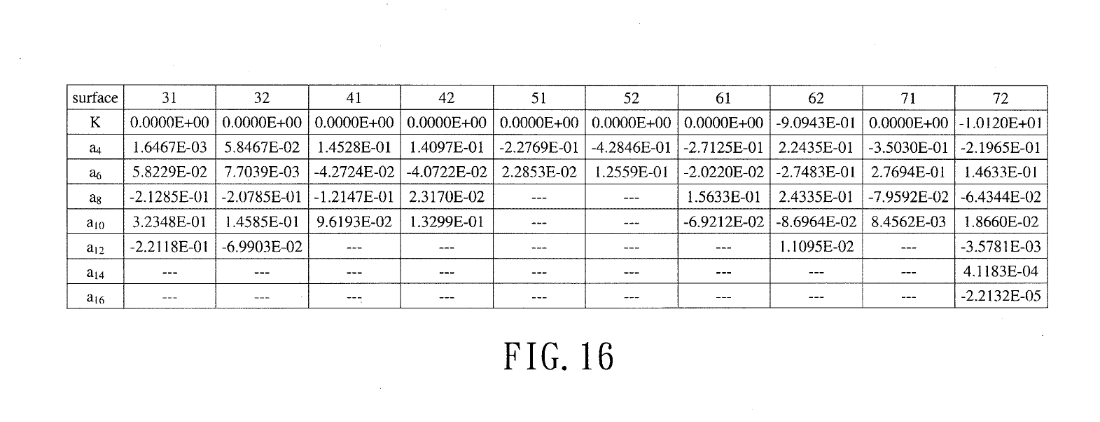

Shown in FIG. 16 is a table that lists values of some optical parameters of the aforementioned optical relationship (1) corresponding to the fourth preferred embodiment.

Relationships among some of the aforementioned optical parameters corresponding to the fourth preferred embodiment are as follows:

CT4/AC34=22.73

CT2/AC23=0.51

CT4/AAG=1.94

CT4/CT2=5.43

CT4/CT3=4.36

AC23/AAG=0.71

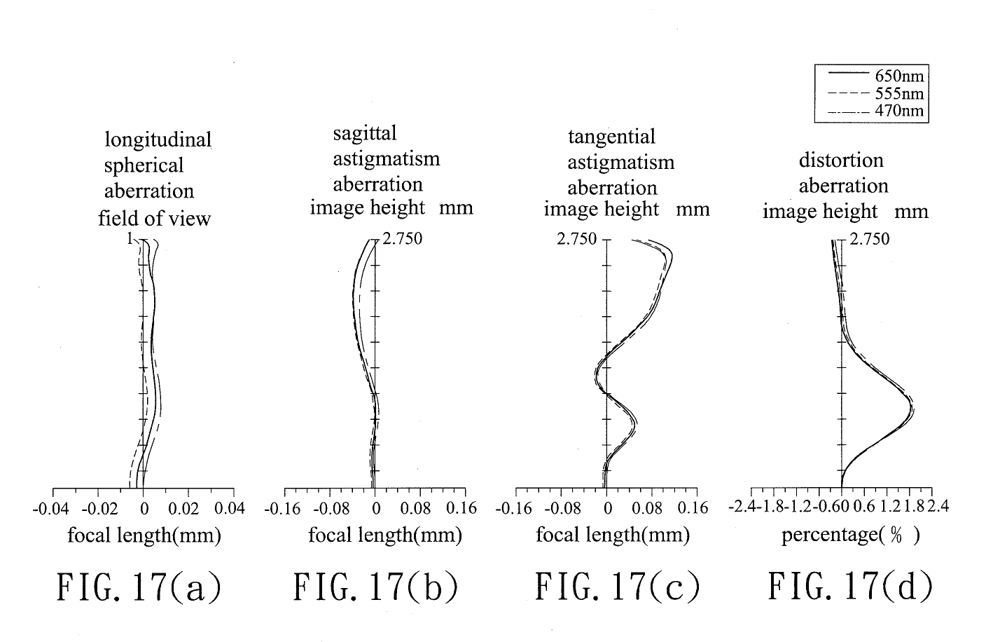

FIGS. 17(a) to 17(d) show simulation results corresponding to longitudinal spherical aberration, sagittal astigmatism aberration, tangential astigmatism aberration, and distortion aberration of the fourth preferred embodiment, respectively. It can be understood from FIGS. 17 (a), 17 (b), 17 (c) and 17 (d) that the fourth preferred embodiment is likewise able to achieve a relatively good optical performance even with the system length reduced down to 4.80 mm.

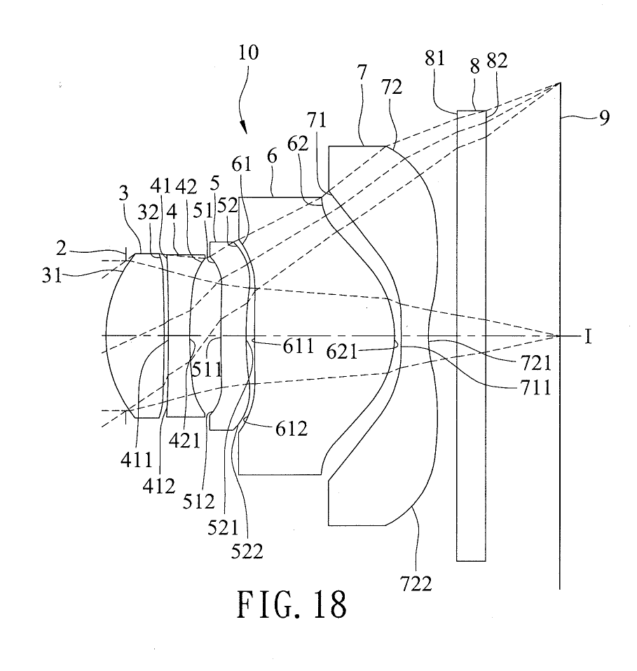

Referring to FIG. 18, the differences between the first and fifth preferred embodiments reside in that:

The third lens element 5 has a negative refractive power. The object-side surface 61 of the fourth lens element 6 has a convex portion 611 in a vicinity of the optical axis (I), and a concave portion 612 in a vicinity of the periphery of the fourth lens element 6.

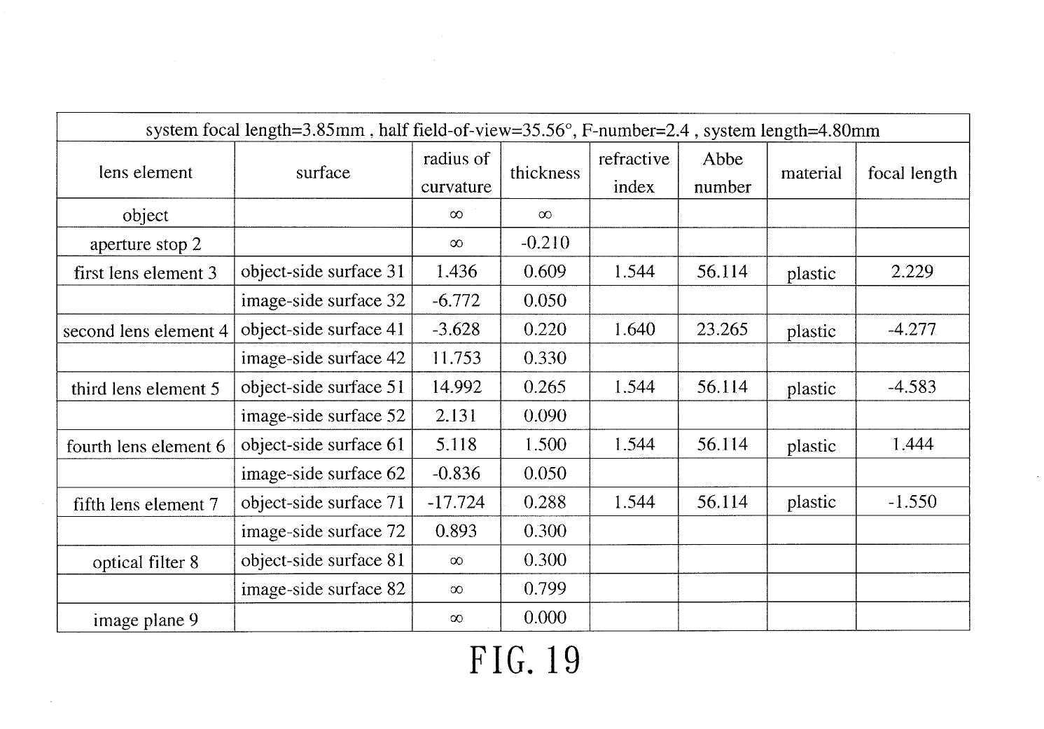

Shown in FIG. 19 is a table that lists values of some optical parameters corresponding to the surfaces 31-71, 32-72 of the fifth preferred embodiment. The imaging lens 10 has an overall system focal length of 3.85 mm, an HFOV of 35.56°, an F-number of 2.4, and a system length of 4.80 mm.

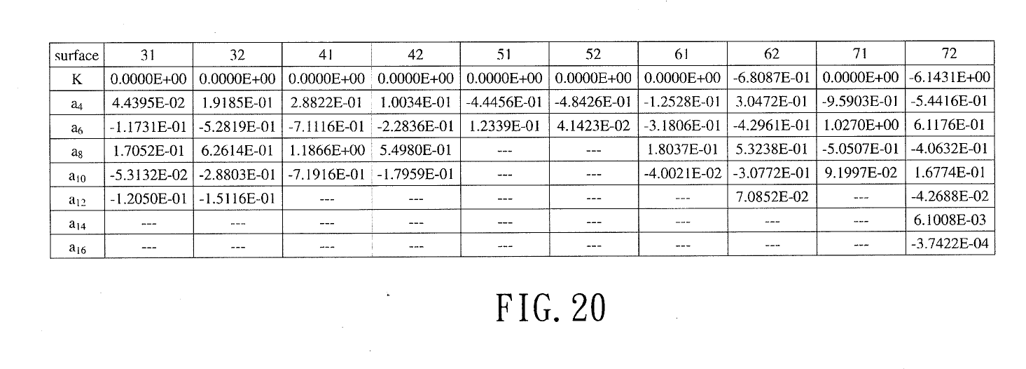

Shown in FIG. 20 is a table that lists values of some optical parameters of the aforementioned optical relationship (1) corresponding to the fifth preferred embodiment.

Relationships among some of the aforementioned optical parameters corresponding to the fifth preferred embodiment are as follows:

CT4/AC34=16.67

CT2/AC23=0.67

CT4/AAG=2.88

CT4/CT2=6.82

CT4/CT3=5.65

AC23/AAG=0.63

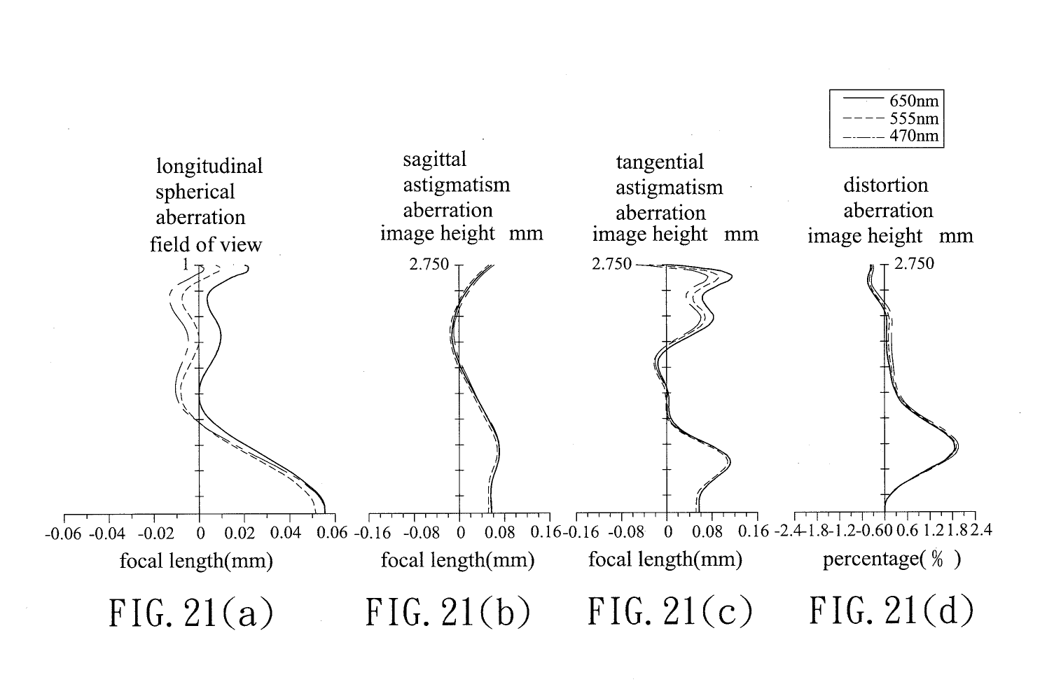

FIGS. 21(a) to 21(d) show simulation results corresponding to longitudinal spherical aberration, sagittal astigmatism aberration, tangential astigmatism aberration, and distortion aberration of the fifth preferred embodiment, respectively. It can be understood from FIGS. 21(a), 21(b), 21(c) and 21(d) that the fifth preferred embodiment is likewise able to achieve a relatively good optical performance even with the system length reduced down to 4.80 mm.

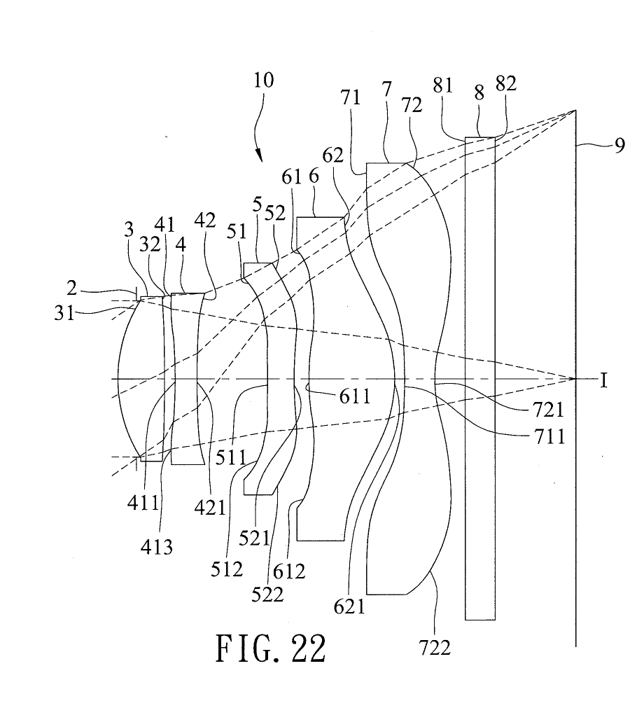

Referring to FIG. 22, the differences between the first and sixth preferred embodiments reside in that:

The object-side surface 41 of the second lens element 4 has a concave portion 411 in a vicinity of the optical axis (I), and a convex portion 413 in a vicinity of the periphery of the second lens element 4. The third lens element 5 has a negative refractive power. The object-side surface 61 of the fourth lens element 6 has a convex portion 611 in a vicinity of the optical axis (I), and a concave portion 612 in a vicinity of the periphery of the fourth lens element 6.

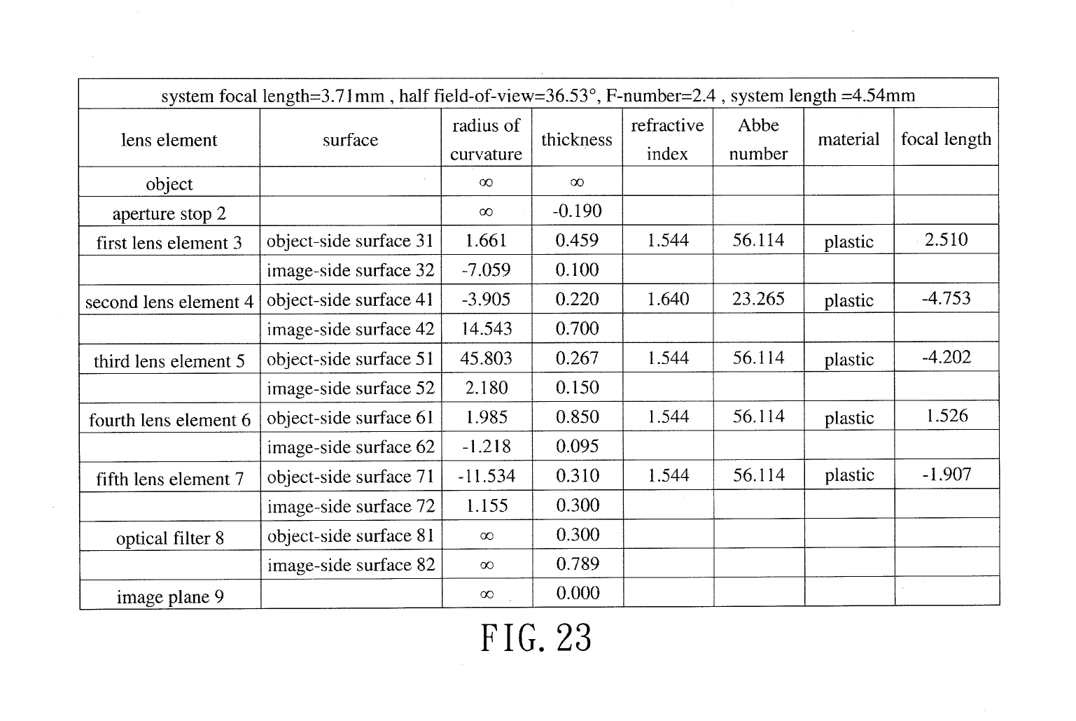

Shown in FIG. 23 is a table that lists values of some optical parameters corresponding to the surfaces 31-71, 32-72 of the sixth preferred embodiment. The imaging lens 10 has an overall system focal length of 3.71 mm, an HFOV of 36.53°, an F-number of 2.4, and a system length of 4.54 mm.

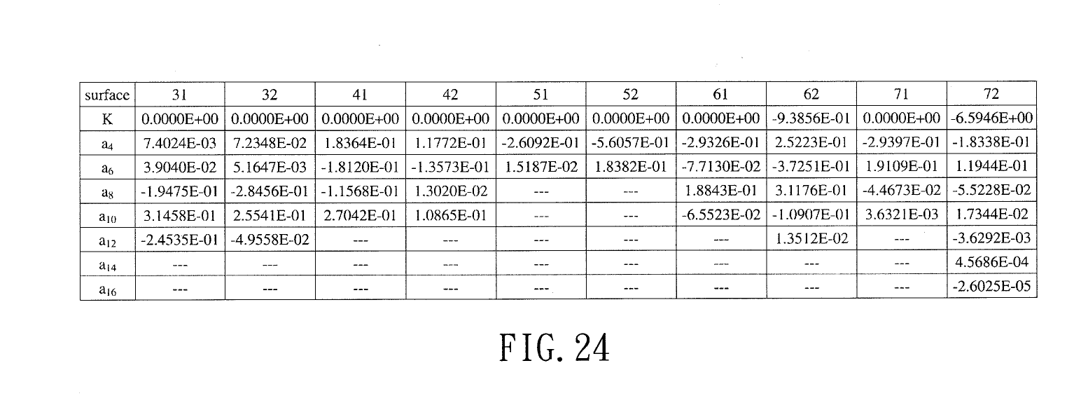

Shown in FIG. 24 is a table that lists values of some optical parameters of the aforementioned optical relationship (1) corresponding to the sixth preferred embodiment.

Relationships among some of the aforementioned optical parameters corresponding to the sixth preferred embodiment are as follows:

CT4/AC34=5.67

CT2/AC23=0.31

CT4/AAG=0.81

CT4/CT2=3.86

CT4/CT3=3.19

AC23/AAG=0.67

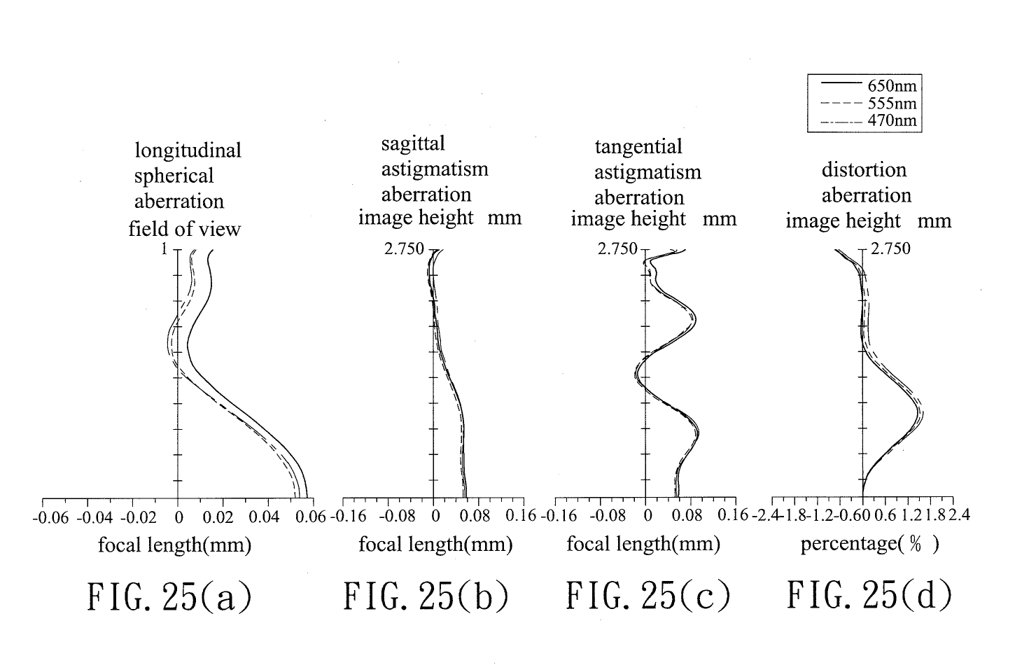

FIGS. 25(a) to 25(d) show simulation results corresponding to longitudinal spherical aberration, sagittal astigmatism aberration, tangential astigmatism aberration, and distortion aberration of the sixth preferred embodiment, respectively. It can be understood from FIGS. 25(a), 25(b), 25 (c) and 25(d) that the sixth preferred embodiment is likewise able to achieve a relatively good optical performance even with the system length reduced down to 4.54 mm.

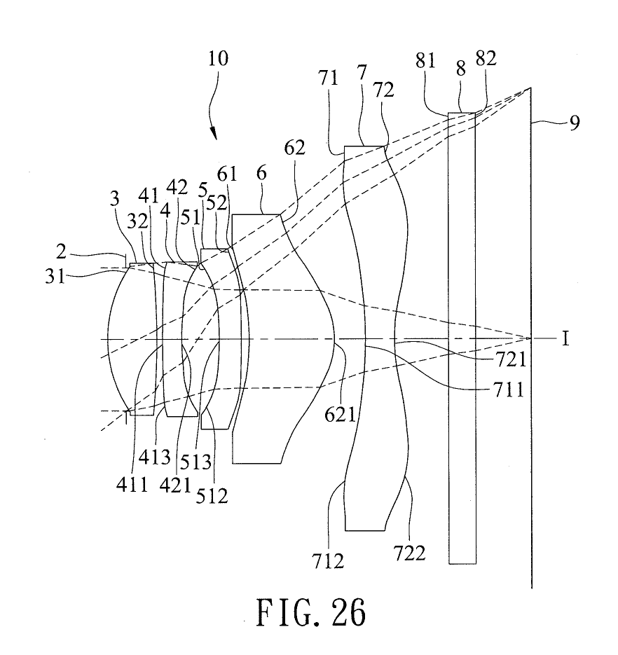

Referring to FIG. 26, the differences between the first and seventh preferred embodiments reside in that:

The object-side surface 41 of the second lens element 4 has a concave portion 411 in a vicinity of the optical axis (I), and a convex portion 413 in a vicinity of the periphery of the second lens element 4. The third lens element 5 has a negative refractive power. The object-side surface 51 of the third lens element 5 has a concave portion 513 in a vicinity of the optical axis (I). The object-side surface 71 of the fifth lens element 7 has a convex portion 712 in a vicinity of the periphery of the fifth lens element 7.

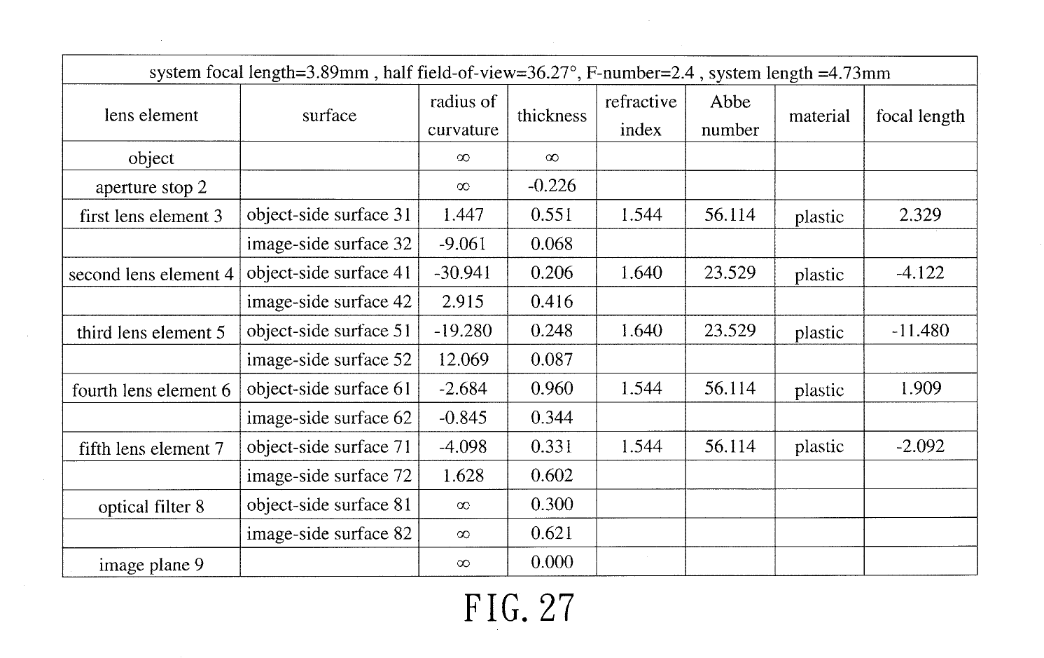

Shown in FIG. 27 is a table that lists values of some optical parameters corresponding to the surfaces 31-71, 32-72 of the seventh preferred embodiment. The imaging lens 10 has an overall system focal length of 3.89 mm, an HFOV of 36.27°, an F-number of 2.4, and a system length of 4.73 mm.

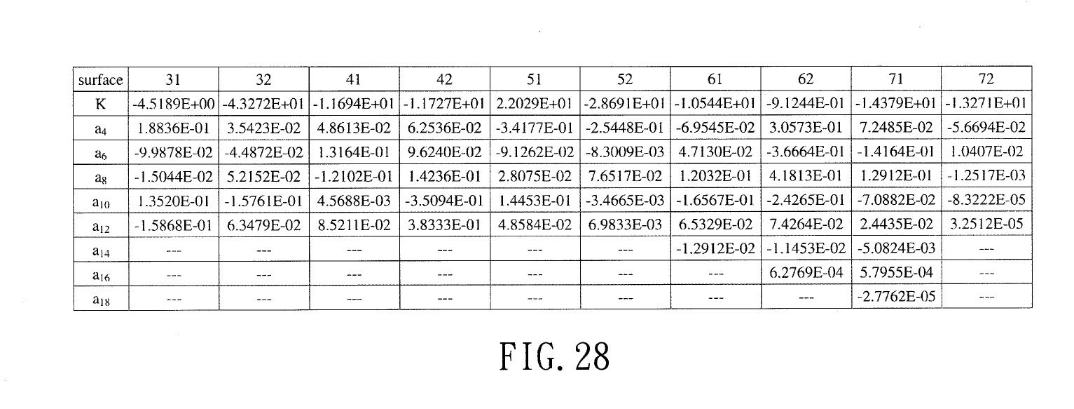

Shown in FIG. 28 is a table that lists values of some optical parameters of the aforementioned optical relationship (1) corresponding to the seventh preferred embodiment.

Relationships among some of the aforementioned optical parameters corresponding to the seventh preferred embodiment are as follows:

CT4/AC34=11.04

CT2/AC23=0.5

CT4/AAG=1.05

CT4/CT2=4.65

CT4/CT3=3.87

AC23/AAG=0.45

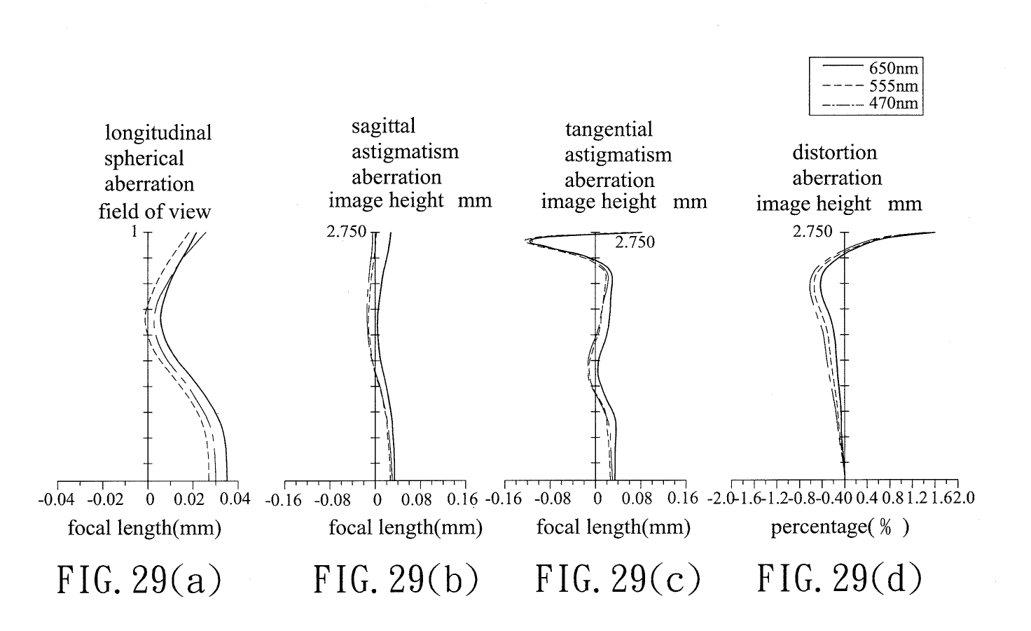

FIGS. 29(a) to 29(d) show simulation results corresponding to longitudinal spherical aberration, sagittal astigmatism aberration, tangential astigmatism aberration, and distortion aberration of the seventh preferred embodiment, respectively. It can be understood from FIGS. 29(a), 29(b), 29(c) and 29(d) that the seventh preferred embodiment is likewise able to achieve a relatively good optical performance even with the system length reduced down to 4.73 mm.

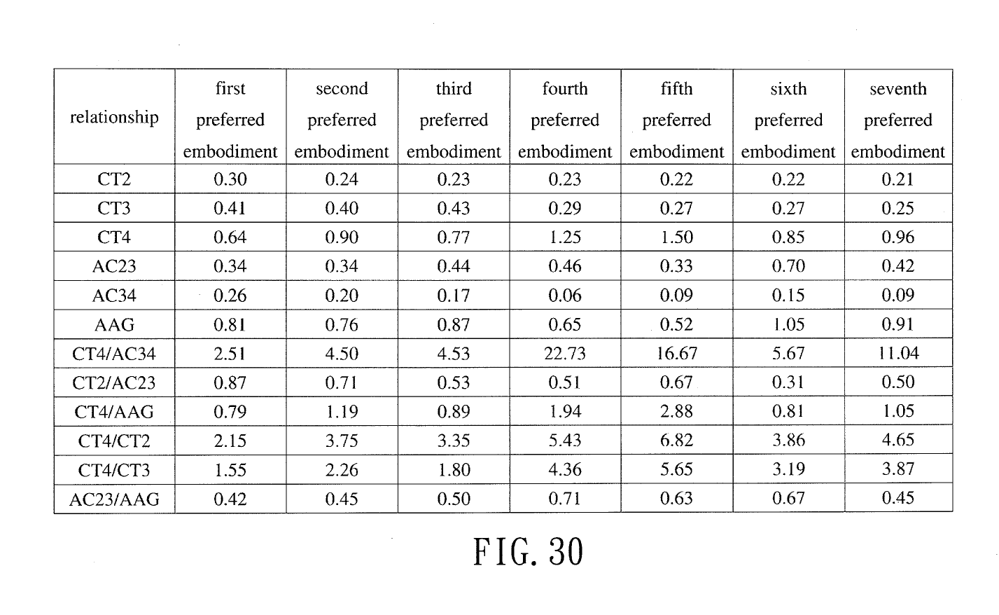

Shown in FIG. 30 is a table that lists the aforesaid relationships among some of the aforementioned optical parameters corresponding to the seven preferred embodiments for comparison. When each of the optical parameters of the imaging lens 10 according to this invention satisfies the following optical relationships, the optical performance is still relatively good even with the reduced system length:

2.50≦CT4/AC34 (2)

CT2/AC23≦0.88 (3)

0.78≦CT4/AAG (4)

3.20≦CT4/CT2 (5)

2.20≦CT4/CT3 (6)

0.45≦AC23/AAG (7)

The fourth lens element 6 usually has a larger optical effective radius, and a greater thickness makes it easy to be produced. A shorter AC23 favors reduction of the system length. Therefore, when the relationship (2) is satisfied, the system length may be reduced with a better configuration. Preferably, 4.5≦CT4/AC34 makes CT4 thicker for facilitating production. The relationship (2) may be provided with an upper limit as: 2.5≦CT4/AC34≦25.

The second lens element 4 usually has a smaller optical effective radius, which allows a smaller thickness of the second lens element 4. Since the image-side surface 42 of the second lens element 4 has the concave portion 421 in the vicinity of the optical axis (I) and the object-side surface 51 of the third lens element 5 has the concave portion 512 in a vicinity of the periphery of the third lens element 5, AC23 has a smaller tolerance to be reduced due to consideration of the edge interference. When the relationship (3) is satisfied, the system length may be reduced with a better configuration. In addition, the relationship (3) may be provided with a lower limit as: 0.2≦CT2/AC23≦0.88, or preferably 0.27≦CT2/AC23≦0.88.

As mentioned above, the fourth lens element 6 usually has a larger optical effective radius, and a greater thickness makes it easy to be produced. A smaller AAG favors reduction of the system length. Therefore, when the relationship (4) is satisfied, the system length may be reduced with a better configuration. Preferably, 1≦CT4/AAG makes CT4 thicker for facilitating production. The relationship (4) may be provided with an upper limit as: 0.78≦CT4/AAG≦3.5, or preferably 0.78≦CT4/AAG≦3.

As mentioned above, the fourth lens element 6 usually has a larger optical effective radius, and a greater thickness makes it easy to be produced. The second lens element 4 usually has a smaller optical effective radius, which allows a smaller thickness of the second lens element 4. Therefore, when the relationship (5) is satisfied, the system length may be reduced with a better configuration. The relationship (5) may be provided with an upper limit as: 3.2≦CT4/CT2≦7.

As mentioned above, the fourth lens element 6 usually has a larger optical effective radius, and a greater thickness makes it easy to be produced. The third lens element 5 usually has a smaller optical effective radius, which allows a smaller thickness of the third lens element 5. Therefore, when the relationship (6) is satisfied, the system length may be reduced with a better configuration. Preferably, 3.8<CT4/CT3 makes CT4 thicker for facilitating production.

The relationship (6) may be provided with an upper limit as: 2.2≦CT4/CT3≦6.3.

Since the image-side surface 42 of the second lens element 4 has the concave portion 421 in the vicinity of the optical axis (I), and the object-side surface 51 of the third lens element 5 has the concave portion 512 in the vicinity of the periphery of the third lens element 5, AC23 may be made larger. Except for AC23, distances between other pairs of adjacent lens elements may be reduced, while a smaller AAG favors reduction of the system length. Therefore, when the relationship (7) is satisfied, distribution of the distances between adjacent lens elements may be better. The relationship (7) may be provided with an upper limit as: 0.45≦AC23/AAG≦0.78.

To sum up, effects and advantages of the imaging lens 10 according to the present invention are described hereinafter.

1. The positive refractive power of the first lens element 3 may enhance converging capability, so as to reduce a chief ray angle of imaging light at a periphery of the sensor, thereby producing parallel light input and ensuring non-distortion of the image.

2. Since the object-side surface 41 of the second lens element 4 has the concave portion 411 in the vicinity of the optical axis (I), and the image-side surface 42 of the second lens element 4 has the concave portion 421 in the vicinity of the optical axis (I), the negative refractive power of the second lens element 4 is enhanced, and image aberration may thus be corrected. Through further cooperation with the convex portion 413 of the object-side surface 41 of the second lens element 4, light passing through areas around the optical axis (I) and around the periphery of the second lens element 4 may be corrected with different extents, resulting in better correction of the image aberration.

3. Since the object-side surface 51 of the third lens element 5 has the concave portion 512 in the vicinity of the periphery of the third lens element 5, light may enter the fourth lens element 6 that has a larger optical effective radius at a suitable position.

When the object-side surface 51 of the third lens element 5 has the concave portion 513 in the vicinity of the optical axis (I), or the image-side surface 52 of the third lens element 5 has the concave portion 521 in the vicinity of the optical axis (I) and the convex portion 522 in the vicinity of the periphery of the third lens element 5, the astigmatism aberration may be corrected.

4. Since the image-side surface 62 of the fourth lens element 6 has the convex portion 621 in the vicinity of the optical axis (I), focusing capability is enhanced. Through further cooperation with the concave portion 711 of the object-side surface 71 of the fifth lens element 7, which is in the vicinity of the optical axis (I), the system length is favored to be reduced.

5. Through design of the relevant optical parameters, such as CT4/AC34, CT2/AC23, CT4/AAG, CT4/CT2, CT4/CT3, and AC23/AAG, optical aberrations, such as spherical aberration, may be reduced or even eliminated. Further, through surface design and arrangement of the lens elements 3-7, even when the system length is reduced, optical aberrations may still be reduced or eliminated, resulting in relatively good optical performance.

6. Through the aforesaid seven preferred embodiments, it is known that the system length of this invention may be reduced down to below 5 mm, so as to facilitate developing thinner relevant products with economic benefits.

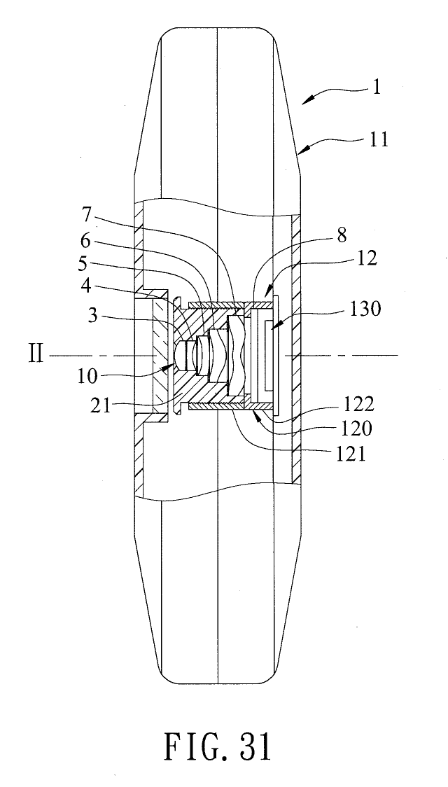

Shown in FIG. 31 is a first exemplary application of the imaging lens 10, in which the imaging lens 10 is disposed in a housing 11 of an electronic apparatus 1 (such as a mobile phone), and forms apart of an imaging module 12 of the electronic apparatus 1. The imaging module 12 includes a barrel 21 on which the imaging lens 10 is disposed, a seat unit 120 on which the barrel 21 is disposed, and an image sensor 130 disposed at the image plane 9 (see FIG. 1) and operatively associated with the imaging lens 10 for capturing images.

The seat unit 120 includes a first seat portion 121 in which the barrel 21 is disposed, and a second seat portion 122 having a portion interposed between the first seat portion 121 and the image sensor 130. The barrel 21 and the first seat portion 121 of the seat unit 120 extend along an axis (II), which coincides with the optical axis (I) of the imaging lens 10.

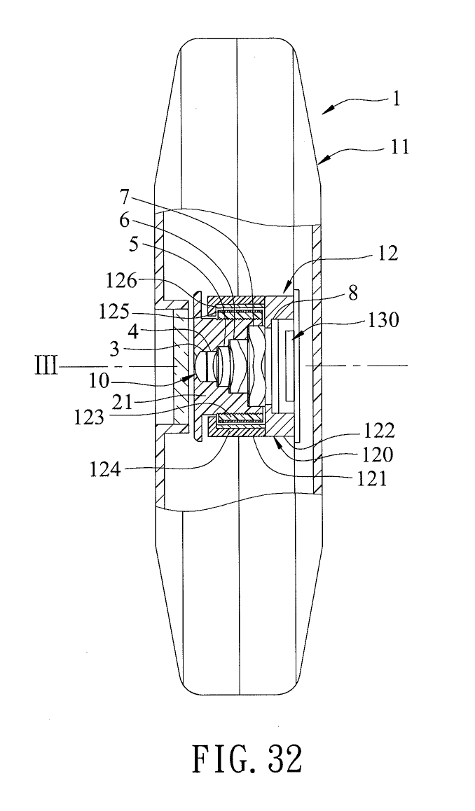

Shown in FIG. 32 is a second exemplary application of the imaging lens 10. The difference between the first and second exemplary applications resides in that, in the second exemplary application, the seat unit 120 is configured as a voice-coil motor (VCM), and the first seat portion 121 includes an inner section 123 in which the barrel 21 is disposed, an outer section 124 that surrounds the inner section 123, a coil 125 that is interposed between the inner and outer sections 123, 124, and a magnetic component 126 that is disposed between an outer side of the coil 125 and an inner side of the outer section 124.

The inner section 123 and the barrel 21, together with the imaging lens 10 therein, are movable with respect to the image sensor 130 along an axis (III), which coincides with the optical axis (I) of the imaging lens 10, for focus control of the imaging lens 10. The optical filter 7 of the imaging lens 10 is disposed at the second seat portion 122, which is disposed to abut against the outer section 124. Configuration and arrangement of other components of the electronic apparatus 1 in the second exemplary application are identical to those in the first exemplary application, and hence will not be described hereinafter for the sake of brevity.

By virtue of the imaging lens 10 of the present invention, the electronic apparatus 1 in each of the exemplary applications may be configured to have a relatively reduced overall thickness with good optical and imaging performance, so as to reduce cost of materials, and satisfy requirements of product miniaturization.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An imaging lens comprising first, second, third, fourth and fifth lens elements arranged from an object side to an image side in the given order, each of said first, second, third, fourth and fifth lens elements having an object-side surface facing toward the object side and an image-side surface facing toward the image side, wherein:
said first lens element has a positive refractive power;
said second lens element has a negative refractive power, said object-side surface of said second lens element having a concave portion in a vicinity of an optical axis of said imaging lens, said image-side surface of said second lens element having a concave portion in a vicinity of the optical axis;
said object-side surface of said third lens element has a concave portion in a vicinity of a periphery of said third lens element;
said image-side surface of said fourth lens element has a convex portion in a vicinity of the optical axis;
said object-side surface of said fifth lens element has a concave portion in a vicinity of the optical axis;
wherein said imaging lens does not include any lens element with refractive power other than said first, second, third, fourth and fifth lens elements.

2. The imaging lens as claimed in claim 1, satisfying 2.5≦CT4/AC34, where CT4 represents a distance between said object-side surface and said image-side surface of said fourth lens element at the optical axis, and AC34 represents a distance between said image-side surface of said third lens element and said object-side surface of said fourth lens element at the optical axis.

3. The imaging lens as claimed in claim 2, further satisfying CT2/AC23≦0.88, where CT2 represents a distance between said object-side surface and said image-side surface of said second lens element at the optical axis, and AC23 represents a distance between said image-side surface of said second lens element and said object-side surface of said third lens element at the optical axis.

4. The imaging lens as claimed in claim 3, further satisfying 0.78≦CT4/AAG, where AAG represents a sum of a distance between said image-side surface of said first lens element and said object-side surface of said second lens element at the optical axis, the distance between said image-side surface of said second lens element and said object-side surface of said third lens element at the optical axis, the distance between said image-side surface of said third lens element and said object-side surface of said fourth lens element at the optical axis, and a distance between said image-side surface of said fourth lens element and said object-side surface of said fifth lens element at the optical axis.

5. The imaging lens as claimed in claim 4, further satisfying 1.00≦CT4/AAG.

6. The imaging lens as claimed in claim 3, wherein said image-side surface of said third lens element has a concave portion in a vicinity of the optical axis, and a convex portion in a vicinity of said periphery of said third lens element.

7. The imaging lens as claimed in claim 6, wherein said object-side surface of said third lens element has a concave portion in a vicinity of the optical axis, and CT4 and AC34 further satisfy 4.50≦CT4/AC34.

8. The imaging lens as claimed in claim 2, further satisfying 0.78≦CT4/AAG, where AAG represents a sum of a distance between said image-side surface of said first lens element and said object-side surface of said second lens element at the optical axis, a distance between said image-side surface of said second lens element and said object-side surface of said third lens element at the optical axis, the distance between said image-side surface of said third lens element and said object-side surface of said fourth lens element at the optical axis, and a distance between said image-side surface of said fourth lens element and said object-side surface of said fifth lens element at the optical axis.

9. The imaging lens as claimed in claim 8, wherein said object-side surface of said second lens element further has a convex portion in a vicinity of a periphery of said second lens element.

10. The imaging lens as claimed in claim 9, further satisfying 3.20≦CT4/CT2, where CT2 represents a distance between said object-side surface and said image-side surface of said second lens element at the optical axis.

11. The imaging lens as claimed in claim 2, wherein said image-side surface of said third lens element further has a concave portion in a vicinity of the optical axis, and a convex portion in a vicinity of said periphery of said third lens element.

12. The imaging lens as claimed in claim 11, further satisfying 0.45≦AC23/AAG, where AC23 represents a distance between said image-side surface of said second lens element and said object-side surface of said third lens element at the optical axis, and
AAG represents a sum of a distance between said image-side surface of said first lens element and said object-side surface of said second lens element at the optical axis, the distance between said image-side surface of said second lens element and said object-side surface of said third lens element at the optical axis, the distance between said image-side surface of said third lens element and said object-side surface of said fourth lens element at the optical axis, and a distance between said image-side surface of said fourth lens element and said object-side surface of said fifth lens element at the optical axis.

13. The imaging lens as claimed in claim 1, satisfying CT2/AC23≦0.88, where CT2 represents a distance between said object-side surface and said image-side surface of said second lens element at the optical axis, and AC23 represents a distance between said image-side surface of said second lens element and said object-side surface of said third lens element at the optical axis.

14. The imaging lens as claimed in claim 13, further satisfying 2.20≦CT4/CT3, where CT4 represents a distance between said object-side surface and said image-side surface of said fourth lens element at the optical axis, and CT3 represents a distance between said object-side surface and said image-side surface of said third lens element at the optical axis.

15. The imaging lens as claimed in claim 14, further satisfying 3.80≦CT4/CT3.

16. An electronic apparatus comprising:
a housing; and
an imaging module disposed in said housing, and including an imaging lens as claimed in claim 1, a barrel on which said imaging lens is disposed, a seat unit on which said barrel is disposed, and an image sensor disposed at the image side and operatively associated with said imaging lens for capturing images.

17. The electronic apparatus as claimed in claim 16, wherein said seat unit includes a first seat portion including an inner section in which said barrel is disposed, and an outer section that surrounds said inner section, said inner section of said first seat portion, said barrel, and said imaging lens being movable together with respect to said image sensor along the optical axis.

18. The electronic apparatus as claimed in claim 17, wherein said seat unit further includes a second seat portion, which is disposed between said outer section of said first seat portion and said image sensor, and which is disposed to abut against said outer section.
